(19) United States
(12) Patent Application Publication
(10) Pub. No.: US 2016/0018197 A1
(43) Pub. Date: Jan. 21, 2016

(54) Coil Spring Screw Mechanism and Spinning and Translating Shooting Target Using Same

(71) Applicants: Tyler J. Dyck, Boissevain (CA); Edward G. Dyck, Boissevain (CA)

(72) Inventor: Tyler J. Dyck, Boissevain (CA)

(21) Appl. No.: 14/720,869

(22) Filed: May 25, 2015

Related U.S. Application Data
(60) Provisional application No. 62/003,188, filed on May 27, 2014.

(51) Int. Cl. F41J 7/04; F16M 13/02

(52) U.S. Cl. CPC F41J 7/04; F16M 13/022

(57) ABSTRACT

In a target apparatus, a coil spring lies on a linear axis and has open space between its adjacent coils. A sleeve disposed externally and rotatably around the coil spring includes a guide feature that reaches radially inward into the open space of the coil spring in a condition slidable along the coils. At least one arm carries a respective target plate on the sleeve at a radial distance outward therefrom. Impact of the target plate rotates the sleeve about the axis in a respective rotational direction, which causes translation of the sleeve along the axis in a respective translational direction due to cooperation between the coil spring and the guide feature on the sleeve. Use of a screw mechanism employing a coil spring instead of threads to cause translation of the sleeve under rotation thereof reduces the risk of functionally-detrimental damage to the screw mechanism by a firearm projectile.

### CROSS REFERENCE TO RELATED APPLICATIONS

This application claims benefit under 35 U.S.C. 119(e) of Provisional Application Ser. No. 62/003,188, filed May 27, 2014.

### FIELD OF THE INVENTION

The present invention relates generally to shooting targets for firearms, and more particularly to such targets that employ a screw mechanism to achieve both rotational and translational movement on an axis when impacted by a projectile.

### BACKGROUND

The present invention is concerned with shooting targets of the general type disclosed in U.S. Pat. No. 6,478,301, the entirely of which is incorporated herein by reference. In the target disclosed in the incorporated reference, a threaded shaft is horizontally supported between two vertical uprights. A spinning target features an internally threaded sleeve that is engaged on the shaft to cooperatively define a screw mechanism therewith, and features radially opposing arms that carry respective target plates at their distal ends. Impact of either target plate with a projectile from a firearm causes the sleeve to rotate in a respective direction around the threaded shaft, and the threaded mating of the shaft and sleeve results in automatic translation or displacement of the sleeve in a respective direction along the shaft during this rotation.

One concern with the prior art design is the potential for damage to occur to the external threading of the shaft when impacted by firearm projectiles, which may then interfere with, or prevent, rotation and translation of the target.

Applicant has developed a unique design for a screw mechanism usable in such a spinning and translating shooting target to address this issue.

### SUMMARY OF THE INVENTION

According to a first aspect of the invention, there is provided a shooting target apparatus comprising:

a coil spring supported in a position extending along and coiling around a linear axis with open space between adjacent coils of the coil spring; and

a spinning target comprising:
a sleeve disposed externally and rotatably around the coil spring, and comprising a guide feature reaching radially inward from the sleeve into the open space of the coil spring in a condition slidable along the adjacent coils of the spring within said open space; and
at least one arm that has a respective proximal end connected to the sleeve and extends away therefrom to a respective target plate carried on said arm;

whereby impact of the respective target plate by a projectile rotates the sleeve about the axis in a respective rotational direction, which causes translation of the sleeve along the axis in a respective translational direction due to cooperation between the coil spring and the guide feature on the sleeve.

Preferably the guide feature comprises at least one guide stud projecting radially inwardly from the sleeve.

Preferably the guide stud is defined by a guide member reaching into an interior of the sleeve through a radial bore of the sleeve.

Preferably the guide stud and the radial bore are matingly threaded.

Preferably there is provided a shaft passing axially through the coil spring and spaced radially inward therefrom in a stationarily held, non-rotatable position, whereby the coil spring coils around a partial length of the shaft with a clearance space present between the shaft and the coil spring.

Preferably there are provided a pair of stops fastened to the shaft at respective positions therealong with the coil spring disposed between said pair of stops.

Preferably ends of the coil spring are held in fixed relation to the shaft.

Preferably ends of the the coil spring are respectively attached to the stops in fixed relation thereto, and the stops are held in fixed relation to the shaft.

Preferably an outer radius of each stop measured from the axis exceeds an outer radius of the coil spring in order to block movement of the sleeve past either stop.

Preferably there are provided first support and second supports, each having a lower end for placement on a ground surface in order to stand said supports in upright positions placing upper ends of said supports at an elevation spaced above said ground surface, and opposing ends of the shaft are connected or connectable to the first and second supports at a distance spaced from the lower ends thereof so as to span between said first and second supports in a stationary, non-rotatable position at a height above said ground surface and thereby carry the coil spring at said height as part of a cross-member spanning between the first and second supports.

Preferably the at least one arm comprises first and second arms extending from the sleeve in generally opposing directions.

According to a second aspect of the invention, there is provided a screw mechanism comprising a coil spring supported in a position extending along and coiling around a linear axis with open space between adjacent coils of the coil spring; and a sleeve disposed externally and rotatably around the coil spring, and comprising a guide feature reaching radially inward from the sleeve into the open space of the coil spring in a condition slidable along the adjacent coils of the spring within said open space, whereby rotation of the sleeve about the axis in a either rotational direction causes translation of the sleeve along the axis in a respective translational direction due to cooperation between the coil spring and the guide feature on the sleeve.

According to a third aspect of the invention, there is provided a shooting target apparatus comprising:

a coil spring supported in a non-rotatable, radially deflectable position extending along and coiling around a linear axis with open space between adjacent coils of the coil spring; and

a spinning target comprising:
a sleeve disposed externally and rotatably around the coil spring, and comprising a guide feature reaching radially inward from the sleeve into the open space of the coil spring in a condition slidable along the adjacent coils of the spring within said open space; and
at least one arm that has a respective proximal end connected to the sleeve and extends away therefrom to a respective target plate carried on said arm;

whereby impact of the respective target plate by a projectile rotates the sleeve about the axis in a respective rotational direction, which causes translation of the sleeve along the axis in a respective translational direction due to cooperation between the coil spring and the guide feature on the sleeve.

### BRIEF DESCRIPTION OF THE DRAWINGS

One embodiment of the invention will now be described in conjunction with the accompanying drawings in which:

FIG. 1 is a perspective view of a shooting target apparatus of the present invention with a spinning and translating target.

FIG. 2 is a partial view of the shooting target apparatus of FIG. 1 (not to scale), in which a sleeve of the spinning and translating target has been cut away in a horizontal plane marked by line II-II of FIG. 1.

FIG. 3 is a partial view of the shooting target apparatus of FIGS. 1 and 2, as cross-sectioned along line III-III of FIG. 2.

In the drawings like characters of reference indicate corresponding parts in the different figures.

### DETAILED DESCRIPTION

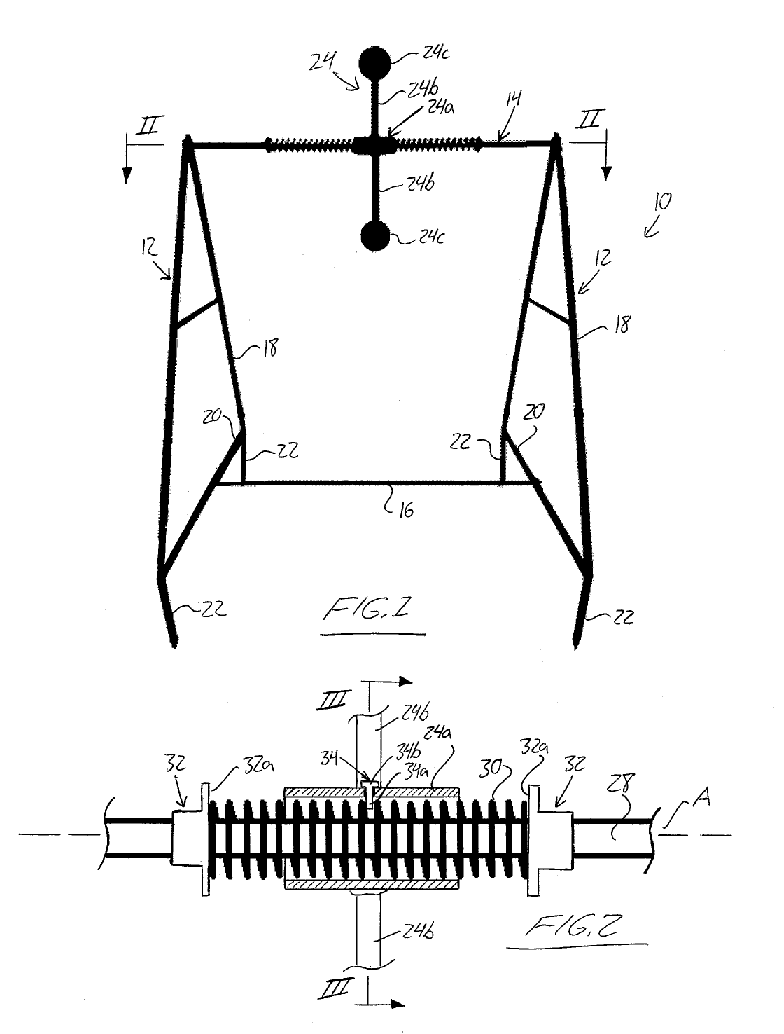

FIG. 1 shows a shooting target apparatus 10 according to one embodiment of the present invention, which features two identical upright supports 12 that are seated atop a horizontal ground surface in order to stand upwardly therefrom in respective vertical planes, and a cross-member 14 that spans horizontally between the two supports 12 at or near the upper ends thereof. A reinforcement member 16 of equal length to the cross-member 14 spans horizontally between the two uprights at an elevation closer to the ground in order to increase a rigidity of the overall framework defined by this assembly. As shown, each upright may be in the form of an A-frame 18 having a base member 20 spanning between its diverging legs at their lower ends, and a pair of vertical feet 22 depending downward from the ends of the base member. However, other structures of suitable upright-form may alternatively be employed to the carry the cross-member 14 at an elevation spaced a distance above the ground.

A spinning target 24 is rotatably supported on the cross-member, and features a rigid, hollow, cylindrical sleeve 24a that closes concentrically around the cross member. A pair of radially opposing arms 24b each have a proximal end thereof attached to the sleeve 24a, for example by welding, and a pair of target plates 24c are each attached to the distal end of a respective one of the arms 24b at a radial distance outward from the sleeve 24a.

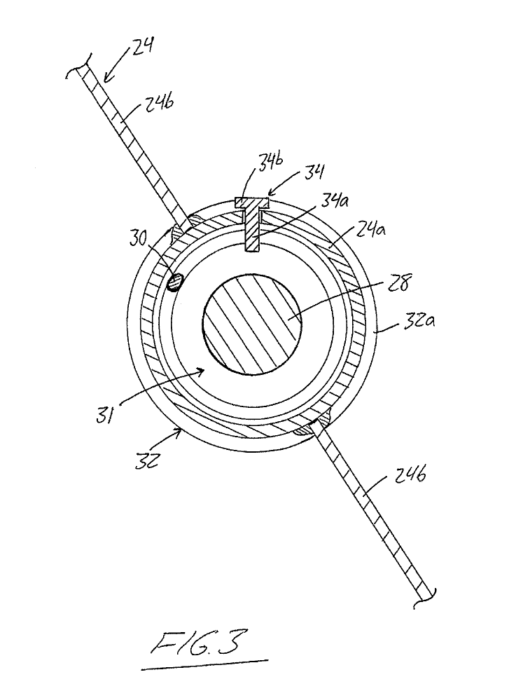

FIG. 2 shows additional detail of the cross-member 14 and the spinning target 24. The cross-member 14 features a shaft 28 whose opposite ends are affixed or fastened to the two upright supports 12 so as to be rigidly fixed or supported in a non-rotatable, stationary position spanning therebetween. The shaft 28 defines an internal component 28 of the cross-member 14 that extends axially and concentrically through a coil spring 30 that that is disposed in a position coiling around and along the internal component on its horizontal, longitudinal axis A. The inner diameter of the coil spring 30 exceeds the outer diameter of the shaft 28, thereby leaving a radial clearance space 31 between the outer circumference of the shaft and the surrounding coil spring 30. The cross-member 14 is completed by a pair of stop collars 32 that are attached to the internal shaft 28 at spaced apart positions along the axis A. The ends of the coil spring abut respectively against the two stop collars 32 at annular end faces 32a thereof that project radially outward from the internal shaft 28 that passes through aligned internal bores of the two stop collars. These ends of the coil spring are welded or otherwise affixed or rigidly fastened to the stops collars 32, which in turn are affixed or rigidly fastened to the shaft, for example by adhesive means, to prevent rotation thereabout and displacement therealong. Accordingly, with the shaft held stationary in a non-rotatable manner by the uprights, the spring is likewise held in a non-rotatable position by the fixed connection of the spring ends to the stop collars. At least at their facing-together annular end faces, the stop collars are of greater outer diameter than the coil spring 30.

The sleeve 24a has an inner diameter that slightly exceeds the outer diameter of the coil spring 30, and is disposed over the spring 30 in a position closing circumferentially therearound in a generally concentric position around the axis A of the internal shaft 28. The outer diameter of each stop collar at the annular end face 32a thereof exceeds the inner diameter of the sleeve 24a, whereby each stop collar 32 blocks axial movement of the sleeve 24a past its end face 32a, thereby limiting the available range of translational movement of the sleeve 24a along the axis A. The two stop collars 32 capture the spring between them in a non-collapsed state, in which axial space remains open between each pair of adjacent coils in the spring 30. It will be appreciated that FIG. 2 is not drawn to scale with FIG. 1, which is more reflective of preferred embodiments, where the axial length of the spring length is more than twice, and preferably several times, the axial length of the sleeve 24a in order to accommodate notable travel of the sleeve relative to the spring in the axial direction.

The sleeve 24a has a radial hole passing through the sleeve wall, and a bolt 34 has its threaded shaft 34a fed through this radial hole from the exterior of the sleeve 24a. The bolt is secured in place on the sleeve 24a, for example through cooperation of internal threading in the radial hole of the sleeve and external threading on the bolt shaft 34a. The bolt is selected to be of such a length that its shaft 34a reaches radially into the interior of the sleeve 24a by a distance that is less than the radial distance between the internal shaft 28 and the interior cylindrical surface of the sleeve 24a, but greater than the radial clearance between the spring 30 and the interior surface of the sleeve. As shown in FIG. 2, the bolt shaft 34a thus reaches into the open axial space between two adjacent coils of the spring 30. As a result, the bolt shaft 34a forms a guide stud that will follow the helical path of the spring's inter-coil space around the shared axis A of the spring and internal shaft when the sleeve is rotated about the axis A. That is, when the sleeve 24a is rotated in a respective direction about the axis A by the impact of a firearm projectile against one of the target plates 24c, the sleeve 24a (and the attached arms 24b and target plates 24c) will be translated along the axis A due to the cooperation between the guide stud 34a and the helical coils of the spring 30.

The illustrated embodiment thus provides the same spinning and translating target functionality of the prior art patent cited in the background section above, but with the unique advantage that because the helical guide track on the cross-member 14 is defined by a coil spring 30 that coils around the shaft at a radial distance therefrom, instead of by integrally formed threads on the shaft 28, the guide track has less potential for damage when impacted by a firearm projectile, as the impacted portion of the spring 30 will elastically deflect under this impact, and then return to its normal default position as the spring resiles back into its original default shape. The radial clearance space between the shaft and the normal default position of the spring allows this momentary radial deflection of the spring 30 toward the shaft, which aborbs some of the energy of the projectile. As a result, even if the spring is deflected far enough to impact against the shaft 28, the amount of impact energy transferred to the shaft 28 is reduced compared to direct impact of the shaft with the projectile, since some of the energy is dissipated by the spring.

The spring 30 is preferably a compression spring that resides between the stop collars 32 in a default fully-uncompressed state in order to maximize the available amount or degree of deflection under impact of the spring by a projectile. However, if the relaxed axial length of the compression spring exceeds the distance between the two stop collars (i.e. if the spring is slightly compressed between the two stop collars), the apparatus would still be expected to operate, provided that that the remaining axial space left between adjacent coils of the partially compressed spring is sufficient to accommodate receipt of the guide stud 34a in this space, and sliding movement of the guide stud 34a within this space. Similarly, a tension spring held in an expanded state sufficient axial space between its adjacent coils to accommodate the guide stud 34a (for example by attachment of the spring's opposing ends to stop collars that are spaced apart by an axial distance exceeding the relaxed, unextended axial length of the spring) would also be expected to function.

To assemble the cross-member 14 and spinning target 24 of the illustrated embodiment, first one of the stop collars 32 is slid onto the shaft 28 from a first end thereof and then releasably or fixedly fastened in place at the desired position thereon. Next, the spring 30 is slid onto the shaft 28 from the opposing second end thereof, and then the sleeve 24a is likewise slid onto the shaft from the second thereof into position around the spring. If the guide stud 34a is pre-installed before such placement of the sleeve 24a, then the sleeve is installed not through a pure axial sliding thereof into place over the spring, but by also turning the sleeve around the axis in order to ‘thread’ the guide stud 34a into the helical space of the spring from one end thereof. Alternatively, an initially studless sleeve may be installed by pure axial sliding, after which point the guide stud 34a is inserted into a preferably-predrilled radial hole in the sleeve in order to reach into the space between two adjacent coils of the spring. The arms and target plates of the spinning target may be pre-attached to the sleeve prior to installation thereof. It will be appreciated that the sleeve and spring may be pre-assembled and then slid onto the shaft together. At the start of the assembly process, the spring (with or without the sleeve) may be slid onto the shaft prior to fastening of the first stop collar thereto.

With the cross-member assembled, it is then connected between the two supports 12 in order to prepare the apparatus for use. Preferably the cross-member and reinforcement member 16 (if included), are releasably fastened to the supports 12 in order to allow subsequent disassembly of these components to a minimal space footprint for storage or transport. The assembly of these components is preferably performed by the consumer, whereby the minimal space footprint can be employed for cost-efficient packing and distribution by the manufacturer, and minimal shelf-space for retailers and distributors. For example, one or both of the stop collars 32 may employ a simple set-screw in order to provide easy and convenient user-installation thereof on the shaft 28, and the guide stud 34a may likewise be simply threaded in place on the sleeve by the end user. Accordingly, the spring and spinning target may be shipped unassembled, thus allowing a generally flat-packed shipping option for the manufacturer.

It will be appreciated that more than one guide stud may be included on the sleeve of the spinning target, and that an inwardly projecting guide stud may be provided by means other than a bolt. Other embodiments may employ other options for a guide feature on the sleeve that follows the helical path laid out by the spring. For example, it is conceived that one embodiment may employ an internally threaded sleeve whose internal threading is selected to match the helical spacing of the spring for a thread-like engagement between the sleeve and the spring, where the spring itself forms acts as a thread crest or ridge on the internal shaft, and the open helical space around the shaft 28 between the spring coils act as the thread root of the internal shaft.

While the illustrated embodiment features a horizontally oriented shaft and spring for horizontal translation of the spinning target along a horizontal axis between two vertical supports, other embodiments may feature vertically or obliquely oriented axial directions in which the spinning target is translated by projectile-induced rotation. In addition, another embodiment may feature just one arm and target plate, although the illustrated configuration of two radially opposing arms and target plates is more preferably, whereby a shooter can cause translation of the spinning target in both directions along the axis without changing which side of the apparatus they are firing from.

It will be appreciated from the forgoing that the spring-defined helical guide track and cooperating sleeve collectively define a screw mechanism that is operable to translate the sleeve along the axis of the coil spring under rotation of the sleeve. Although originally developed for use in a shooting target of the type discussed above, such a screw mechanism may be used in other applications, and may have particular advantage or benefit in applications where the screw mechanism is similarly exposed to impact by projectiles or other objects, or other operating harsh conditions.

Since various modifications can be made in my invention as herein above described, and many apparently widely different embodiments of same made within the scope of the claims without departure from such scope, it is intended that all matter contained in the accompanying specification shall be interpreted as illustrative only and not in a limiting sense.

1. A shooting target apparatus comprising:
a coil spring supported in a position extending along and coiling around a linear axis with open space between adjacent coils of the coil spring; and
a spinning target comprising:
a sleeve disposed externally and rotatably around the coil spring, and comprising a guide feature reaching radially inward from the sleeve into the open space of the coil spring in a condition slidable along the adjacent coils of the spring within said open space; and
at least one arm that has a respective proximal end connected to the sleeve and extends away therefrom to a respective target plate carried on said arm;
whereby impact of the respective target plate by a projectile rotates the sleeve about the axis in a respective rotational direction, which causes translation of the sleeve along the axis in a respective translational direction due to cooperation between the coil spring and the guide feature on the sleeve.

2. The apparatus of claim 1 wherein the guide feature comprises at least one guide stud projecting radially inwardly from the sleeve.

4. The apparatus of claim 2 wherein the guide stud is defined by a guide member reaching into an interior of the sleeve through a radial bore of the sleeve.

5. The apparatus of claim 2 wherein the guide stud and the radial bore are matingly threaded.

6. The apparatus of claim 1 comprising a shaft passing axially through the coil spring and spaced radially inward therefrom in a stationarily held, non-rotatable position, whereby the coil spring coils around a partial length of the shaft with a clearance space present between the shaft and the coil spring.

7. The apparatus of claim 6 comprising a pair of stops fastened to the shaft at respective positions therealong with the coil spring disposed between said pair of stops.

8. The apparatus of claim 6 wherein ends of the coil spring are held in fixed relation to the shaft.

9. The apparatus of claim 7 wherein ends of the the coil spring are respectively attached to the stops in fixed relation thereto, and the stops are held in fixed relation to the shaft.

10. The apparatus of claim 7 wherein an outer radius of each stop measured from the axis exceeds an outer radius of the coil spring in order to block movement of the sleeve past either stop.

11. The apparatus of claim 6 comprising a first support and a second support each having a lower end for placement on a ground surface in order to stand said supports in upright positions placing upper ends of said supports at an elevation spaced above said ground surface, wherein opposing ends of the shaft are connected or connectable to the first and second supports at a distance spaced from the lower ends thereof so as to span between said first and second supports in a stationary, non-rotatable position at a height above said ground surface and thereby carry the coil spring at said height as part of a cross-member spanning between the first and second supports.

12. The apparatus of claim 1 wherein the at least one arm comprises first and second arms extending from the sleeve in generally opposing directions.

13. The apparatus of claim 1 wherein the spring is held in a non-rotatable condition.

14. A screw mechanism comprising a coil spring supported in a position extending along and coiling around a linear axis with open space between adjacent coils of the coil spring; and a sleeve disposed externally and rotatably around the coil spring, and comprising a guide feature reaching radially inward from the sleeve into the open space of the coil spring in a condition slidable along the adjacent coils of the spring within said open space, whereby rotation of the sleeve about the axis in a either rotational direction causes translation of the sleeve along the axis in a respective translational direction due to cooperation between the coil spring and the guide feature on the sleeve.

15. The screw mechanism of claim 14 wherein the guide feature comprises at least one guide stud projecting radially inwardly from the sleeve.

16. The apparatus of claim 15 wherein the guide stud is defined by a guide member reaching into an interior of the sleeve through a radial bore of the sleeve.

17. The apparatus of claim 16 wherein the guide stud and the radial bore are matingly threaded.

18. The mechanism of claim 14 wherein the spring is held in a non-rotatable condition.

19. The mechanism of claim 14 comprising a shaft passing axially through the coil spring and spaced radially inward therefrom in a stationarily held, non-rotatable position, whereby the coil spring coils around a partial length of the shaft with a clearance space present between the shaft and the coil spring.

20. A shooting target apparatus comprising:
a coil spring supported in a non-rotatable, radially deflectable position extending along and coiling around a linear axis with open space between adjacent coils of the coil spring; and
a spinning target comprising:
a sleeve disposed externally and rotatably around the coil spring, and comprising a guide feature reaching radially inward from the sleeve into the open space of the coil spring in a condition slidable along the adjacent coils of the spring within said open space; and
at least one arm that has a respective proximal end connected to the sleeve and extends away therefrom to a respective target plate carried on said arm;
whereby impact of the respective target plate by a projectile rotates the sleeve about the axis in a respective rotational direction, which causes translation of the sleeve along the axis in a respective translational direction due to cooperation between the coil spring and the guide feature on the sleeve.
